(19) United States
(12) Patent Application Publication
(10) Pub. No.: US 2005/0094899 A1
(43) Pub. Date: May 5, 2005

(54) Adaptive image upscaling method and apparatus

(76) Inventors: Changick Kim, Cupertino, CA (US); Jincheng Huang, Sunnyvale, CA (US); Vasudev Bhaskaran, Sunnyvale, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/696,472

(22) Filed: Oct. 29, 2003

(51) Int. Cl. G06K 9/32

(52) U.S. Cl. 382/300

(57) ABSTRACT

A method for upscaling image data is provided. The method initiates with identifying a gradient value associated with a pixel location of the image data. Then, it is determined whether a direction associated with the pixel location is either a horizontal direction or a vertical direction. Next, a weighted interpolation scheme is applied to the pixel location when the direction is either a horizontal direction or a vertical direction. A method for applying an interpolation scheme where inter-frame redundancies are exploited is included. A computer readable media, a system for processing block based image data and an integrated circuit for scaling image data are also provided.

### BACKGROUND OF THE INVENTION

1. Field of the Invention

This invention relates generally to digital image technology and more particularly to a method and apparatus for upscaling image frames to any size for presentation, while preserving high frequency components in the upscaled image frame.

2. Description of the Related Art

Data defining image frames are commonly upscaled for presentation. Small sized image frames for presentation on handheld multimedia displays, may be upscaled in order to display the small sized image frames on a display monitor having a larger or denser array of available image pixels, e.g., multimedia liquid crystal display (LCD) projectors and high definition television.

However, the expanded image is characterized by jagged edges and degradation of details from the interpolation methods. Conventional interpolation methods, e.g., zero order, nearest neighbor, bilinear and bicubic interpolation, for upscaling an image, focus primarily on enlargement of the image for presentation. However, these interpolation methods are inadequate for capturing both the sharp edges and the smoothly varying density of the original image. In essence, the conventional interpolation methods do not preserve edges as the image data is upscaled.

Additionally, one of the constraints imposed on these interpolation schemes with respect to video data, e.g., videoconference image data, is that the volume of data being transmitted is kept to a minimum. In addition, the computational complexity for any scheme used to improve the quality when upscaling image data associated with video frames, must be low in order to not impact the quality of the video presentation. As such, spatially adaptive cubic interpolation methods and multi-frame interpolation methods using sub-pixel motion information are incapable of being applied to video due to their computational complexity and requirement of multiple frames for each image.

As a result, there is a need to solve the problems of the prior art to provide a method and apparatus for upscaling image data so that the upscaled image data more accurately portrays the sharp edge features and other details of the original image. In addition, with respect to video, there is a need to perform the upscaling in a manner that does not adversely impact the video presentation.

### SUMMARY OF THE INVENTION

Broadly speaking, the present invention fills these needs by providing a method and system for upscaling image data while preserving high frequency components in the upscaled image through adaptively applying a weighted interpolation scheme. In addition, a motion aware video scaling technique is provided, that prevents video decoders from wasting resources for redundant upscaling. It should be appreciated that the present invention can be implemented in numerous ways, including as a method, a system, computer code associated with a computer readable medium, or a device. Several inventive embodiments of the present invention are described below.

In one embodiment, a method for upscaling image data is provided. The method initiates with identifying a gradient value associated with a pixel location of the image data. Then, it is determined whether a direction associated with the pixel location is either a horizontal direction or a vertical direction. Next, a weighted interpolation scheme is applied to the pixel location when the direction is either a horizontal direction or a vertical direction.

In another embodiment, a method for scaling video data is provided. The method initiates with determining whether a block of image data of a current frame is flagged to indicate a level of difference with a corresponding block of image data of a previous frame. If the block of image data of the current frame is flagged to indicate a level of difference with the corresponding block of image data of the previous frame, then the method includes applying a weighted interpolation scheme adaptively to each pixel location within the block of image data of the current frame based upon a direction associated with the pixel location.

In yet another embodiment, a computer readable medium having program instructions for upscaling image data is provided. The computer readable medium includes program instructions for identifying a gradient value associated with a pixel location of the image data. Program instructions for determining whether a direction associated with the pixel location is either a horizontal direction or a vertical direction and program instructions for applying a weighted interpolation scheme to the pixel location when the direction is either a horizontal direction or a vertical direction are included.

In still yet another embodiment, a computer readable medium having program instructions for scaling video data is provided. The computer readable medium includes program instructions for determining whether a block of image data of a current frame is flagged to indicate a level of difference with a corresponding block of image data of a previous frame. Program instructions for applying a weighted interpolation scheme adaptively to a pixel location within the block of image data of the current frame based upon a direction associated with the pixel location when the block of image data of the current frame is flagged to indicate a level of difference with the corresponding block of image data of the previous frame are included.

In another embodiment, a system for processing block based image data is provided. The system includes an encoder configured to compress video data. The encoder is configured to set a coded block indicator to a first value when inter-frame redundancies between corresponding blocks of successive frames of a video stream exceed a threshold value. The encoder is further configured to set the coded block indicator to a second value when the inter frame redundancies between successive frames of a video stream are less than or equal to the threshold value. A decoder configured to decompress the video data is included. A scaling module configured to scale the decompressed video data is also included. The scaling module includes circuitry for identifying the coded block indicator for each block. The scaling module further includes circuitry for adaptively applying a weighted interpolation scheme to a pixel location within a current frame when the coded block indicator is equal to the first value.

In yet another embodiment, an integrated circuit capable of scaling image data is provided. The integrated circuit includes logic for calculating a gradient value associated with a pixel location of the image data. Logic for determining whether an angle defined by a vector associated with the gradient value and an axis is either a substantially parallel angle or a substantially perpendicular angle is included. Logic for applying a weighted interpolation scheme to the pixel location when the direction is either 1) a horizontal direction and a vertical direction and 2) the gradient value exceeds a threshold value.

In still yet another embodiment, an integrated circuit for scaling video data is provided. The integrated circuit includes logic for determining whether a block of image data of a current frame is flagged to indicate a level of difference with a corresponding block of image data of a previous frame. Logic for applying a weighted interpolation scheme adaptively to a pixel location within the block of image data of the current frame based upon a direction associated with the pixel location is included. The block of image data of the current frame is associated with a flag indicative of a level of difference with the corresponding block of image data of the previous frame. Logic for applying a bilinear interpolation scheme when the direction associated with the pixel location excludes the weighted interpolation scheme is also included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating the labeling of points used in two dimensional interpolation.

FIGS. 2A and 2B are graphs representing the transformation process of variable t to v through t′ for a weighted interpolation scheme in accordance with one embodiment of the invention.

FIGS. 2C and 2D are graphs representing the corresponding impacts for a weighted interpolation and a linear interpolation, respectively, in accordance with one embodiment of the invention.

FIGS. 3A-3D represent an original image and three interpolation schemes upscaling the original image data by 4× in each dimension.

FIG. 4A-4C illustrate quarter common intermediate format (QCIF) images upscaled by 4× where different interpolation schemes were applied to the QCIF images.

FIG. 5 is an exemplary image defined in QCIF having vertical and horizontal edge regions which is subsequently upscaled through the embodiments described herein.

FIGS. 6A-6C illustrate corresponding 4×upscaled images associated with region 122 of FIG. 5.

FIGS. 7A-7C illustrate corresponding 4×upscaled images associated with region 124 of FIG. 5.

FIG. 8 illustrates an arbitrarily resized video frame (176×144→408×156), which is being decoded and displayed from an H.263 decoder incorporated with the proposed upscaling algorithm.

FIG. 9 is a flow chart diagram illustrating the method operations for upscaling image data in accordance with one embodiment of the invention.

FIG. 10 illustrates a simplified schematic diagram of a system for processing block-based image data utilizing weighted interpolation and the motion aware video scaling in accordance with one embodiment of the invention.

### DETAILED DESCRIPTION OF THE PREFERRED EMBODIMENTS

An invention is described for a system, apparatus and method for a weighted interpolation scheme to be adaptively applied to upscale image data, as well as a scheme for enabling the adaptive weighted interpolation scheme to be applied to video data through a non-computationally complex manner. It will be obvious, however, to one skilled in the art, that the present invention may be practiced without some or all of these specific details. In other instances, well known process operations have not been described in detail in order not to unnecessarily obscure the present invention.

The embodiments of the present invention provide a method and a system to upscale image data where the sharpness of the edge regions of the original image data are preserved in the upscaled image. A weighted interpolation scheme that transforms the two dimensional coordinates of the original image through a sigmoidal function so as to place more weight on positions close to tabulated points. The weighted interpolation is selectively applied to both horizontal and vertical edge points. The horizontal and vertical edge components are identified through the use of directional components corresponding to gradient vectors. The calculations of the angle of the gradient and a magnitude of the gradient yield values through which it is determined if the pixel location, i.e., the two dimensional coordinates of the pixel, is associated with a horizontal or vertical edge region. Where the two dimensional coordinates are not associated with a horizontal or edge region, a conventional interpolation technique, e.g., bilinear interpolation, is applied to the image data. In one embodiment, the weighted interpolation scheme is adaptively to video data. Here, inter-frame redundancies in the video stream are identified for a current frame in order to eliminate the recalculation of a scaling function applied to a preceding frame of data.

In multidimensional interpolation, it is possible to obtain an estimate of y(x₁,x₂,x_{d}) from a d-dimensional grid of tabulated values y and d one-dimensional vectors giving the tabulated values of each of the independent variables x₁,x₂,x_{d}. It should be appreciated that the problem of interpolating on a mesh that is not Cartesian, i.e., has tabulated function values at “random” points in n-dimensional space rather than at the vertices of a rectangular array is not discussed in detail herein. For illustrative purposes, the specific examples for the case of two dimensions is discussed below. However, it will be apparent to one skilled in the art that the cases of three or more dimensions are analogous to the two dimension case discussed herein.

In two dimensions, a matrix of functional values ya[m][n], where m varies from 0 to M−1, and n varies from 0 to N−1, is defined. Here, an array xa₁ of length m, and an array xa₂ of length n are also provided. The mathematical relationship relation of these input quantities to an underlying function y(x₁, x₂) is:
ya[m][n]=y(xa₁[m],xa₂[n]) (1)

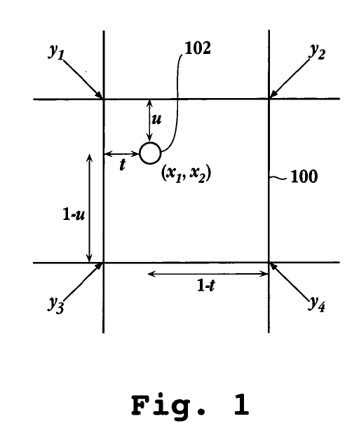

FIG. 1 is a simplified schematic diagram illustrating the labeling of points used in two dimensional interpolation. Here, the function y at some untabulated point (x₁, x₂) is interpolated. One concept associated with the interpolation is the grid square. The grid square, is defined by the square connecting four tabulated points y₁, y₂, y₃, and y₄, which surround desired interior point 102. For convenience, points y₁, y₂, y₃, and y₄ are numbered clockwise starting from the upper-left in FIG. 1. More precisely, if
xa₁[m]≦x₁≦xaₐ[m+l]
xa₂[m]≦x₂≦xa₂[n+1] (2)
defines m and n, then
y₁≡ya[m][n]
y₂≡ya[m][n+1]
y₃≡ya[m+1][n+1]
y₄≡ya[m+1][n]
One commonly applied interpolation scheme in two dimensions is bilinear interpolation on the grid square. The formulas associated with bilinear interpolation include:
t≡(x₁−xa₁[m])/(xa₁[m+1]−xa₁[m]) (4)
u≡(x₂−xa₂[n])/(xa₂[n+1]−xa₂[n])
(so that t and u each lie between 0 and 1) and the bilinear interpolated value y(x₁, x₂) at (x₁, x₂) is
y(x₁,x₂)=(1−t)(1−u)y₁+t(1−u)y₂+tuy₃+(1−t)uy₄ (5)

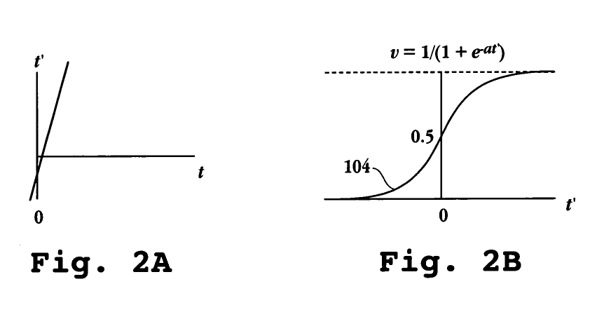

Since conventional interpolations, including bilinear interpolation focuses on smooth enlargement of an image, it is not configured to restore the original high resolution image. If high frequency components can be reserved in the upscaled image, a sharper upscaled image may obtained from the original image. As described below, weighted interpolation is exploited along both horizontal and vertical edge points. For points other than horizontal and vertical edge points, bilinear interpolation is applied. The weighted interpolation scheme described herein, places more weight to positions close to tabulated points (i.e., y₁, y₂, y₃, y₄ in FIG. 1) so that sharp transitions happen in edge areas. Accordingly, the variables t (and u) are transformed to v (and w) via t′ (and u′). Both variables lie between 0 and 1, but v (and w) have a Sigmoidal shape for t′ (and u′), which is scaled and shifted from t (and u). FIGS. 2A and 2B are graphs representing the transformation process of variable t to t′ for a weighted interpolation scheme in accordance with one embodiment of the invention. The calculations performed for the transformation of t to v are represented mathematically below:

$$\begin{matrix}{t}^{′} = ( t \times 10 ) - 5 , {u}^{′} = ( u \times 10 ) - 5 , & ( 6 ) \\ v = \frac{1}{1 + {ⅇ}^{- {at}^{′}}} , w = \frac{1}{1 + {ⅇ}^{- {au}^{′}}} & ( 7 )\end{matrix}$$

where v and w each lie between 0 and 1.
Thus, the weighted interpolated value y(x₁, x₂) at (x₁, x₂) is
y(x₁,x₂)=(1−v)(1−w)y₁+v(1−w)y₂+vwy₃+(1−v)wy₄ (8)
The sigmoidal shape of trace 104 of FIG. 2B enables a sharper image to be defined when performing an upscale operation at an identified vertical or horizontal edge.

Furthermore, to prevent sharp transitions in the smooth areas of the image, the weighted interpolation is adaptively applied according to the gradient values at each pixel location. Here, the gradient of an image f(x,y) at location (x,y) is defined as the two-dimensional vector, defined as:

$$G [ f ( x , y ) ] = [ \begin{matrix}{G}_{x} \\ {G}_{y}\end{matrix} ] = [ \begin{matrix}\frac{\partial f}{\partial x} \\ \frac{\partial g}{\partial y}\end{matrix} ] \qquad ( 9 )$$

It should be appreciated that from Eq. (9) the computation of the gradient is based on obtaining the partial derivatives ∂f/∂x and ∂f/∂y at every pixel location. One skilled in the art will appreciate that the partial derivatives may be obtained in a number of ways to do this. One approach conducted here is shown in Eq. (10). The component of the gradient vector in the x (horizontal) direction is defined as:
Gₓ=∂f/∂x=f(x,y−1)−f(x,y+1) (10)
and in the y (vertical) direction the component is defined as:
G_{y}=∂f/∂y=f(x−1,y)−f(x+1,y) (11)
Thus, the gradient vector in the x direction looks at a pixel value to the left (f(x,y−1)) and the right (f(x,y+1)) of the pixel location, while the gradient vector in the y direction looks at a pixel value above (f(x+1,y)) and below (f(x−1,y)) the pixel location. From the above definitions, it is possible to calculate the approximate magnitude of the gradient, defined as:
|G[f(x, y)]=|Gₓ+|G_{y}.
Letting α(x, y) represent the direction angle of G at location (x,y), it follows from vector analysis that
α(x,y)=tan⁻¹(G_{y}/Gₓ)×180/π
where the angle is measured with respect to the x axis. Of course, the embodiments described herein may calculate the angle relative to the y axis.

To prevent unnecessary abrupt transition in the upscaled image, the weighted interpolation is applied if the approximated magnitude is greater than a certain value and the direction of the pixel is either horizontal or vertical, in one embodiment. That is, this functionality is captured in the psuedo code below:

if (((α(x,y) = horizontal)OR(α(x,y) = vertical)) AND (|G[f(x,y)]| > θ))
then Do weighted_interpolation
Otherwise Do bilinear_interpolation

FIGS. 2C and 2D are graphs representing the corresponding impacts for a weighted interpolation scheme and bi-linear interpolation scheme, respectively, in accordance with one embodiment of the invention. FIG. 2C utilizes a sigmoidal function corresponding to trace 105a to capture a horizontal or vertical edge being upscaled by a factor of 4× from pixel value a to pixel value b. FIG. 2D utilizes a bilinear interpolation technique corresponding to trace 105b for the 4× upscaling at the horizontal or vertical edge. Comparing the graphs of FIGS. 2C and 2D illustrate the effect of the use of a sigmoidal function for the weighted interpolation as compared to the bilinear interpolation. For example, at point 107a, the weighted interpolation result of FIG. 2C defined through the sigmoidal function, places a higher relative weight to value “a” than the bilinear interpolation of FIG. 2D. That is, for the bilinear interpolation, ¾ of the value of “a” and ¼ of the value of “b” provides value 107b associated with point 1, which may represent a pixel location in the upscaled image. However, the sigmoidal function of FIG. 2C may apply 15/16 of the value of “a” and 1/16 of the value of “b” to provide value 107a associated with point 1. Thus, the bilinear interpolation is smoothing the edge transition and the sigmoidal function maintains the sharpness of the edge transition. It should be appreciated that the values used above are for exemplary purposes and that any suitable values may be used to define the weighted interpolation for a value in an upscaled image relative to the original image data value.

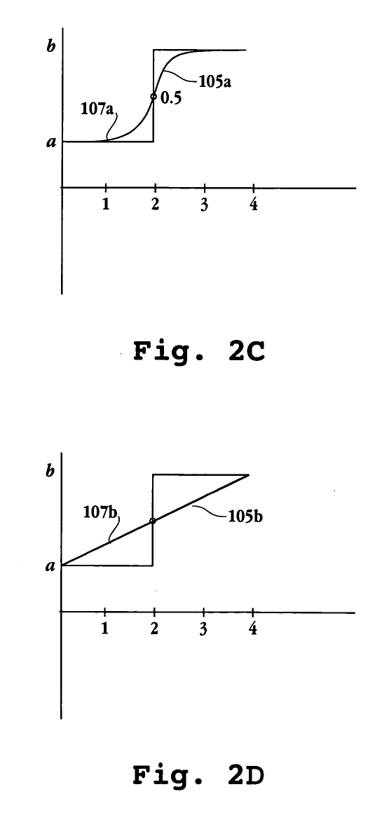

FIGS. 3A-3D represent an original image and three interpolation schemes upscaling the original image data by 4× in each dimension. FIG. 3A represents the original image data. FIGS. 3B-3C are expanded portions of region 106 of FIG. 3A. FIG. 3B utilizes a bilinear interpolation for defining the upscaled data. FIG. 3C utilizes a bicubic interplolation, while FIG. 3D utilizes a weighted interpolation to derive the upscaled data. As can be seen through comparing region 108b, 108c, and 108d, the bilinear and bicubic interpolations of FIGS. 3B and 3C yield fuzzy or blurred transitions for the horizontal edge regions. However, the edge regions of FIG. 3D are sharp. The same effect may be observed for corresponding vertical edge regions of FIG. 3B-3D.

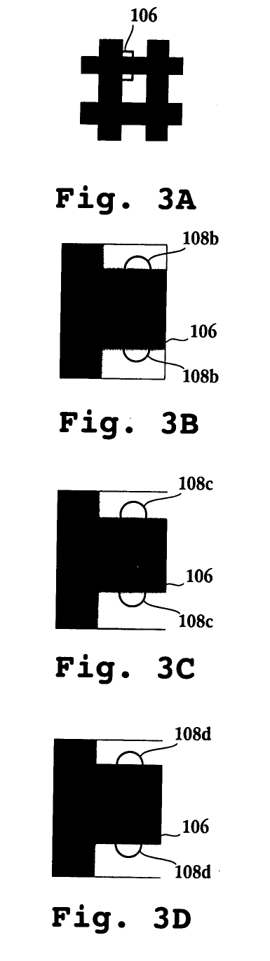

FIG. 4A-4C illustrate quarter common intermediate format (QCIF) images upscaled by 4× where different interpolation schemes were applied to the QCIF images. FIG. 4A utilized bilinear interpolation, FIG. 4B utilized bicubic interpolation and FIG. 4C utilized the weighted interpolation scheme defined herein. It should be appreciated that the horizontal and vertical edges defined within regions 110a-c, 112a-c, 114a-c and 116a-c for the corresponding figures, illustrate the sharper edge definition obtained through the weighted interpolation scheme (FIG. 4C). As can be seen, the horizontal and vertical edges in FIG. 4C are sharper than those in either of FIG. 4A and FIG. 4B.

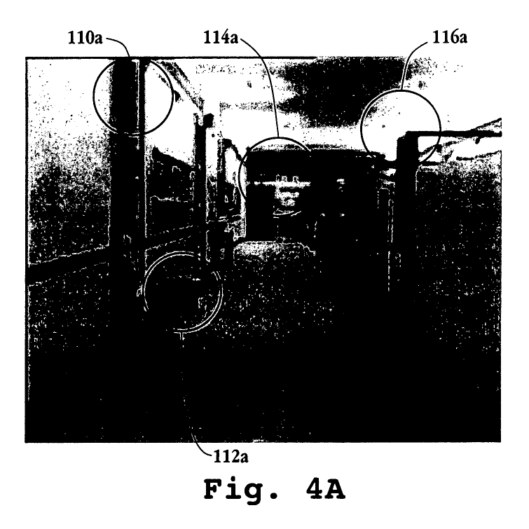

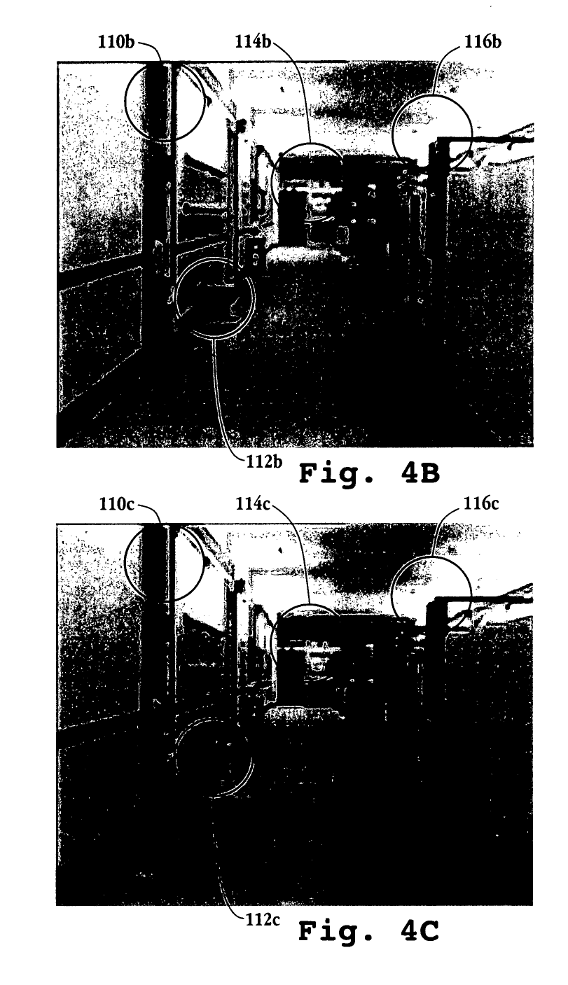

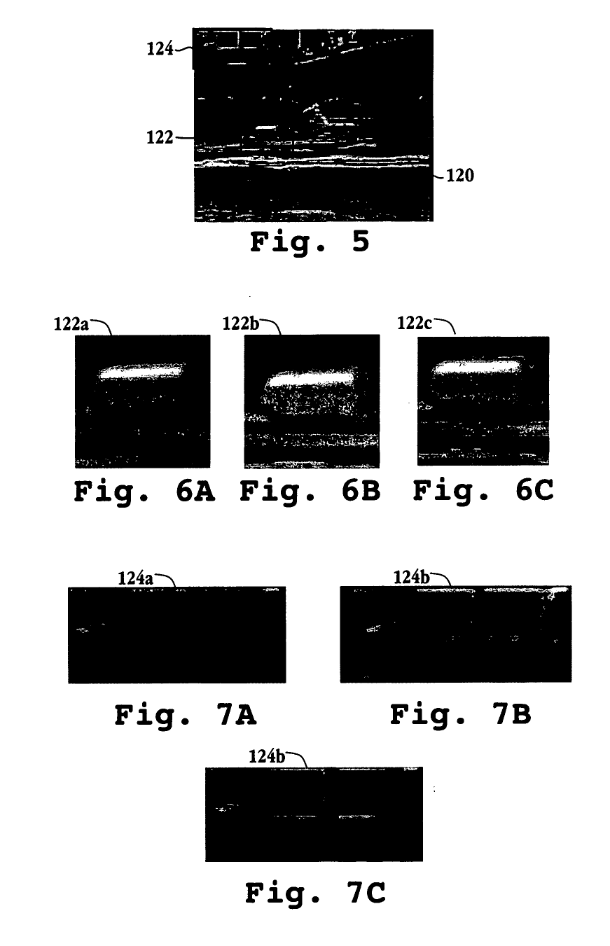

FIG. 5 is an exemplary image defined in QCIF having vertical and horizontal edge regions which is subsequently upscaled through the embodiments described herein. FIGS. 6A-6C illustrate corresponding 4×upscaled images associated with region 122 of FIG. 5. FIG. 6A utilized bilinear interpolation for upscaling, FIG. 6B utilized bicubic interpolation for upscaling and FIG. 6C utilized the weighted interpolation scheme defined herein for upsclaing. FIGS. 7A-7C illustrate corresponding 4×upscaled images associated with region 124 of FIG. 5. FIG. 7A utilized bilinear interpolation, FIG. 7B utilized bicubic interpolation and FIG. 7C utilized the weighted interpolation scheme. In either case, the weighted interpolation algorithm shows sharper vertical and horizontal edges than those by either bilinear or bicubic interpolation.

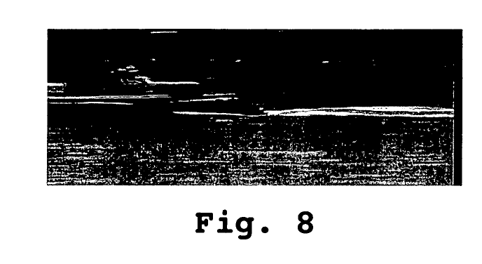

It should be appreciated that the proposed algorithm is not restricted to 4× upscaling. It can be used for any size of up/down-scaling, i.e., 4×, 7×, 8×, 5.5×, 7.7×, 0.5× and so on. For instance, FIG. 8 illustrates an arbitrarily resized video frame (176×144→408×156), which is being decoded and displayed from an H.263 decoder incorporated with the proposed upscaling algorithm. That is, the embodiments described above may be used to resize input image data into any arbitrary size, due to the pixel based nature of the interpolation scheme, as opposed to schemes based on blocks or templates for resizing.

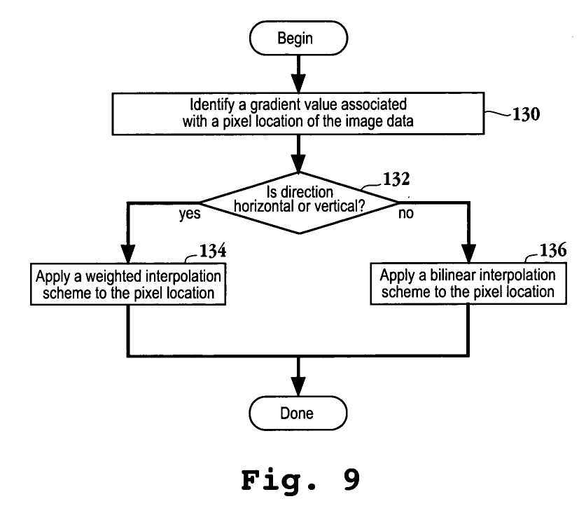

FIG. 9 is a flow chart diagram illustrating the method operations for upscaling image data in accordance with one embodiment of the invention. The method initiates with operation 130 where a gradient value associated with a pixel location of the image data is identified. The gradient value is defined as a two-dimensional vector as discussed above with reference to Equation 9. The computation of the gradient is based on obtaining partial derivatives at each pixel location. The method then advances to decision operation 132 where it is determined whether a direction associated with pixel location is either a horizontal direction or a vertical direction. Here, the component of the gradient vector in either the horizontal or vertical direction is computed relative to pixels located on either side of the pixel location or pixels located above and below the pixel location. In addition, a magnitude associated with the gradient is also calculated here. A direction angle associated with the pixel location is then computed based upon the horizontal component and the vertical component which was previously calculated. From the direction angle, whether the pixel is associated with a horizontal or vertical direction will be determined. If the direction associated with the pixel is not horizontal or vertical, then the method moves to operation 133, where a bilinear interpolation scheme is applied to the pixel location.

When the direction is either a horizontal direction or a vertical direction the method of FIG. 9 then proceeds from operation 132 to operation 134 where a weighted interpolation scheme is applied to the pixel location. In one embodiment, the weighted interpolation scheme is applied when both the direction angle is either horizontal or vertical and the magnitude of the gradient is above a threshold level. Therefore, when the direction associated with the pixel location is non-horizontal or non-vertical or the magnitude is less than the threshold value a bilinear interpolation scheme is applied to the pixel location, as represented by operation 133. The weighted interpolation scheme discussed above with reference to FIGS. 2A through 2D is applied adaptively based upon the direction of the pixel in a magnitude of the gradient. One skilled in the art will appreciate that other commonly used interpolation schemes, e.g., bicubic interpolation, may be used in place of the bilinear interpolation in operation 133. The weighted interpolation scheme transforms coordinates representing the pixel location through a function having a sigmoidal shape as discussed above. This transformation enables a higher weight to be assigned to positions close to tabulated points as discussed above. It should be appreciated that the embodiments described with reference to FIG. 9 may be applied to video data that is being scaled.

As discussed below in more detail, a motion aware technique may be combined with the weighted interpolation scheme in order to efficiently upscale video image data. Here, a block of image data of a current frame is flagged to indicate a level of difference with a corresponding block of image data of a previous frame. That is, an amount of movement is calculated by comparing pixel differences in corresponding locations between the frames. If the sum of the pixel differences are greater than a certain level, then the block of image data is flagged to indicate that it is different than the previous frame. If the sum of absolute differences (SAD) in the pixel values is not above the threshold value, then the block of image data is flagged to indicate a level of similarity with the corresponding frame. Thus, upon decoding the video image data the flag will be used to indicate whether to apply a weighted interpolation scheme as described herein, or just to use the previous block from the previous frame when there is not a significant level of difference between the blocks of the corresponding frames. It should be appreciated that the adaptive application of the weighted interpolation scheme does not affect the quality of the incoming video as the video data is decoded because of the level of redundancy typically found between frames. That is, the nature of the motion aware scaling described herein exploits the significant amount of inter-frame redundancies in the video stream to avoid redundant upscaling.

In one embodiment, the weighted interpolation scheme may be adaptively applied, i.e., where a frame of video data has significant redundancies relative to a previous frame of video data, the scaling function need not be recalculated. This application of the scaling function is referred to as motion-aware scaling. In order to improve the quality of the a system receiving the video data, which is typically of QCIF resolution (176×144) and has to be displayed on a LCD panel with VGA or higher resolution for an application such as video conferencing, the video is rescaled prior to display. Traditional image-based scaling schemes typically use some form of pixel based scaling function such as bilinear interpolation, or bicubic spline filtering, in order to achieve the higher spatial resolution. These scaling schemes are usually not aware of the fact that the video being scaled was originally in H.263-compressed format. The primary motivation behind motion-aware scaling is that there is significant amount of inter-frame redundancies in the video stream. Thus, a scaling function that is applied to some regions of a previous frame need not to be recalculated for a subsequent frame in regions where there is significant redundancies relative to the previous frame.

In one embodiment, motion-aware scaling is implemented within a H.263 codec. It will be apparent to one skilled in the art that the embodiments described herein may be applied to any suitable block based codec and the H.263 codec is used for illustrative purposes only. Here, in the encoding stage, a coded macroblock indication (COD) (1-bit) is set to zero if at least one block of the macroblock (MB) is coded and set to one if the whole MB is not coded. That is, there is a frame to frame comparison of corresponding macro blocks to determine if the corresponding macro blocks are similar so that the scaling may be copied from the earlier in time frame, or if the corresponding macro blocks are different enough to calculate the scaling function for that block. In the decoding stage, the scaled contents of the non-coded macro block are copied from the same position of the last decoded picture. To expedite the scaling process, the above-mentioned motion aware technique may be combined to the weighted interpolation scheme described above. Thus, for each macro block in the reconstructed (or decoded) image frame, the weighted interpolation scheme is applied to a corresponding horizontal or vertical edge if the COD of the macro block is zero, while the super scaled area of that macro block in the last displayed picture is copied and used for display if the COD is one. If the edge region is not a vertical or horizontal edge region, or the magnitude of the gradient is less than a threshold value, then the weighted interpolation is not performed as discussed above. It should be appreciated that this motion-aware scheme can be combined and used with any suitable scaling scheme. The motion aware (MA) scheme has been found to reduce the processing time (defined as decoding time+super scaling time) by a maximum of 45% compared to the processing time without motion-awareness for a purely software-only solution as illustrated in TABLE 1.

TABLE 1

| | | | Processing time ratio |
|---|---|---|---|
| Video | Bit-rate (bps) | Interpolation | (with MA/ (without MA)) |
| Video data | 24k | Bilinear | 0.61 |
| (in QCIF) | | Adaptive | 0.56 |
| | 32k | Bilinear | 0.82 |
| | | Adaptive | 0.69 |
| | 40k | Bilinear | 0.85 |
| | | Adaptive | 0.73 |
| | 55k | Bilinear | 1 |
| | | Adaptive | 0.88 |

Table 1 shows the reduction ratio in processing time for two interpolation schemes; one interpolation scheme is the well-known bilinear interpolation and the other is the weighted interpolation scheme described herein. In the low bit-rate cases, the processing time (sec/frame) of the motion-aware (MA) scheme is reduced by about 30˜45% comparing to that of the scheme without motion awareness in both interpolation schemes. The reduction is more salient in the case of adaptive interpolation because it is more computationally intensive than bilinear interpolation. Additionally, as the compressed bit rate increases, the reduction in the processing time is reduced. The motion-aware scheme tends to be less effective at a higher bit rate. This is due to the circumstance where the number of skipped macro blocks in the encoder becomes smaller as the bit rate becomes higher. The ratios shown in Table 1 are also dependent on the content of the video sequences. For sequences with stable background, such as head-and-shoulder type videos, many macro blocks are not encoded and skipped. Of course this information (COD) is coded into a bit stream. For sequences captured by a moving camera, the proposed motion-aware scheme has little effect since the number of skipped macro blocks is almost zero. However, with respect to multiple point video conferencing system, where video sequences are mostly captured by fixed cameras, the motion aware scheme is a powerful addition.

In another embodiment, this motion-aware scheme can be combined with MICROSOFT WINDOWS DIRECTX based scaling schemes which tend to use (a) hardware acceleration available through the graphics subsystem of the personal computer, and, (b) INTEL'S Multi Media Extensions (MMX) instruction level parallelism. Here, some of the features of motion-aware scaling are used as a helper function to the native Direct X scaling. Therefore, the best of both worlds are captured, namely the inherent hardware/software advantages of Direct X based scaling coupled with making the Direct X based scaling be motion-aware. It should be appreciated that the proposed algorithm does not require complex computations while generating sharper transitions in the high frequency areas. Thus, it is appropriate for real-time image upscaling for video presentation on various multimedia display, such as a multimedia LCD projector and HDTV.

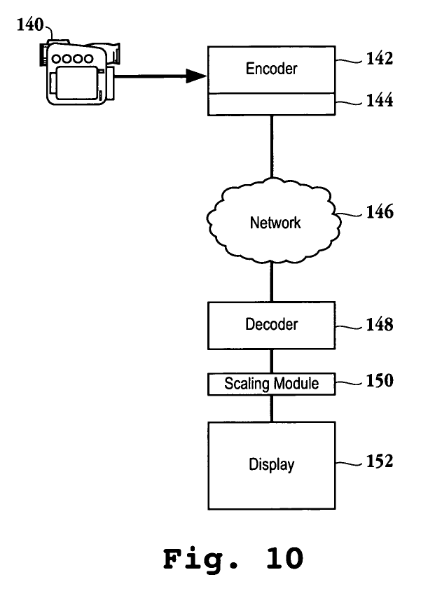

FIG. 10 illustrates a simplified schematic diagram of a system for processing block-based image data utilizing weighted interpolation and the motion aware video scaling in accordance with one embodiment of the invention. Image capture device 140 captures image data and the image data is encoded through encoder 142. The encoder 142 includes coded macro block indication logic 144. The coded macro block indication logic 144 associates a flag with the macro block that corresponds to a level of difference between the macro block and a macro block from the previous frame. The encoded data is then transmitted through network 146 to decoder 148. Decoder 148 then decompresses the image data through generally known techniques. The decoded image data is then received by scaling module 150. Scaling module 150 performs the upscaling technique described herein on the decompressed image data. That is, scaling module 150 is configured to adaptively apply the weighted interpolation scheme and incorporate the motion aware technique described above. Scaling module 150 includes logic for identifying the coded block indicator for each block of data in order to determine whether to apply a weighted interpolation scheme or to apply some other interpolation scheme. The scaled video image data is then displayed on display module 152.

One skilled in the art will appreciate that the scaling module may be implemented as either hardware or software. The software will encompass the functionality described above with reference to FIGS. 2A-2D, 9 and 10. The hardware implementation may be synthesized from the software code through a suitable hardware description language (HDL), such as Verilog. Thus, the hardware implementation may include a chip having circuitry, i.e., logic gates that executes the functionality for the weighted interpolation and the motion aware techniques described herein. Scaling module 150 of FIG. 10 may be incorporated on such an integrated circuit. Alternatively, scaling module 150 may be integrated into decoder 148 rather than being a separate module.

In summary, the embodiments described herein provide a method and a system that preserves high frequency components in order to provided the sharpness of horizontal and vertical edge regions during upscaling processes. The horizontal and vertical edge regions are identified through a gradient, which is derived through the computation of partial derivatives at each pixel location. An angle associated with the gradient is then calculated in order to determine whether the pixel location is a horizontal or vertical edge region. A weighted interpolation scheme is then applied to the identified horizontal or vertical edge regions. Here, a sigmoidal function is used in order to place a higher weight on positions close to tabulated points. In another embodiment, the weighted interpolation scheme, or any other suitable scaling scheme, is applied adaptively through a motion aware scheme in order to accommodate the restrictions in a video environment. The motion aware scheme is configured to recognize inter-frame redundancies in order to eliminate unnecessary calculations.

With the above embodiments in mind, it should be understood that the invention may employ various computer-implemented operations involving data stored in computer systems. These operations include operations requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The above-described invention may be practiced with other computer system configurations including hand-held devices, microprocessor systems, microprocessor-based or programmable consumer electronics, minicomputers, mainframe computers and

1. A method for upscaling image data, comprising:
identifying a gradient value associated with a pixel location of the image data;
determining whether a direction associated with the pixel location is a horizontal direction or a vertical direction; and
applying a weighted interpolation scheme to a value corresponding to the pixel location when the direction is a horizontal direction or a vertical direction.

2. The method of claim 1, further comprising:
applying a bilinear interpolation scheme or a bicubic interpolation scheme to the value corresponding to the pixel location when the direction is non-horizontal direction or a non-vertical direction.

3. The method of claim 1, wherein the method operation of identifying a gradient value associated with a pixel location of the image data includes,
determining a partial derivative associated with the pixel location.

4. The method of claim 1, wherein the method operation of determining whether a direction associated with the pixel location is a horizontal direction or a vertical direction includes,
defining a horizontal component of the gradient value;
defining a vertical component of the gradient value; and
calculating a magnitude of the gradient value from the horizontal component and the vertical component.

5. The method of claim 4, further comprising:
computing a direction angle associated with the pixel location based upon both the horizontal component and the vertical component; and
comparing the magnitude of the gradient value to a threshold value, wherein if the threshold value is greater than the magnitude, the method includes,
applying a bilinear interpolation scheme or a bicubic interpolation scheme to the value corresponding to the pixel location irrespective of the direction.

6. The method of claim 5, wherein the method operation of computing a direction angle associated with the pixel location based upon both the horizontal component and the vertical component includes,
defining the direction angle relative to a horizontal axis.

7. The method of claim 4, wherein the method operation of defining a horizontal component of the gradient value includes,
defining a partial derivative where a horizontal direction variable is held constant.

8. The method of claim 4, wherein the method operation of defining a vertical component of the gradient value includes,
defining a partial derivative where a vertical direction variable is held constant.

9. The method of claim 1, wherein the gradient is defined as a two dimensional vector.

10. The method of claim 1, wherein the method operation of applying a weighted interpolation scheme to the pixel location when the direction is a horizontal direction or a vertical direction includes,
transforming coordinates representing the pixel location through a function having a sigmoidal shape.

11. A method for scaling video data, comprising:
determining whether a block of image data of a current frame is flagged to indicate a level of difference with a corresponding block of image data of a previous frame;
if the block of image data of the current frame is flagged to indicate a level of difference with the corresponding block of image data of the previous frame, then the method includes;
applying a weighted interpolation scheme adaptively to each pixel location within the block of image data of the current frame based upon a direction associated with the pixel location.

12. The method of claim 11, wherein if the block of image data of a current frame is flagged to indicate a level of redundancy with the corresponding block of image data of the previous frame, then the method includes;
copying upscaled data representing the corresponding block of image data of the previous frame into an upscaled block of image data of the current frame.

13. The method of claim 11, wherein the method operation of applying a weighted interpolation scheme adaptively to each pixel location within the block of image data of the current frame based upon a direction associated with the pixel location includes,
determining whether a direction associated with a pixel is a horizontal direction or a vertical direction.

14. The method of claim 13, further comprising:
identifying a gradient value associated with the pixel;
defining a horizontal component of the gradient value;
defining a vertical component of the gradient value; and
calculating a magnitude of the gradient value from the horizontal component and the vertical component.

15. The method of claim 11, wherein the method operation of applying a weighted interpolation scheme adaptively to each pixel location within the block of image data of the current frame based upon a direction associated with the pixel location includes,
transforming coordinates representing a particular pixel location through a function associated with a sigmoidal shape.

16. The method of claim 14, further comprising
computing a direction angle associated with each pixel location based upon both the horizontal component and the vertical component; and
comparing the magnitude of the gradient value to a threshold value, wherein if the threshold value is greater than the magnitude, the method includes,
applying of a bilinear interpolation scheme or a bicubic interpolation scheme to a value corresponding to the pixel location.

17. A computer readable medium having program instructions for upscaling image data, comprising:
program instructions for identifying a gradient value associated with a pixel location of the image data;
program instructions for determining whether a direction associated with the pixel location is of a horizontal direction or a vertical direction; and
program instructions for applying a weighted interpolation scheme to the pixel location when the direction is a horizontal direction or a vertical direction.

18. The computer readable medium of claim 17, further comprising:
program instructions for applying a bilinear interpolation scheme or a bicubic interpolation scheme to the pixel location when the direction is a non-horizontal direction or a non-vertical direction.

19. The computer readable medium of claim 17, wherein the program instructions for identifying a gradient value associated with a pixel location of the image data includes,
program instructions for determining a partial derivative associated with the pixel location.

20. The computer readable medium of claim 17, wherein the program instructions for determining whether a direction associated with the pixel location is of a horizontal direction or a vertical direction includes,
program instructions for defining a horizontal component of the gradient value;
program instructions for defining a vertical component of the gradient value; and
program instructions for calculating a magnitude of the gradient value from the horizontal component and the vertical component.

21. The computer readable medium of claim 20, further comprising:
program instructions for computing a direction angle associated with the pixel location based upon both the horizontal component and the vertical component; and
program instructions for comparing the magnitude of the gradient value to a threshold value; and
program instructions for applying a bilinear interpolation scheme or a bicubic interpolation scheme to the pixel location when the magnitude of the gradient value exceeds the threshold value.

22. The computer readable medium of claim 17, wherein the program instructions for applying a weighted interpolation scheme to the pixel location when the direction is a horizontal direction or a vertical direction includes,
program instructions for transforming coordinates representing the pixel location through a function having a sigmoidal shape.

23. A computer readable medium having program instructions for scaling video data, comprising:
program instructions for determining whether a block of image data of a current frame is flagged to indicate a level of difference with a corresponding block of image data of a previous frame; and
program instructions for applying a weighted interpolation scheme adaptively to a pixel location within the block of image data of the current frame based upon a direction associated with the pixel location when the block of image data of the current frame is flagged to indicate a level of difference with the corresponding block of image data of the previous frame.

24. The computer readable medium of claim 23, wherein the program instructions for applying a weighted interpolation scheme adaptively to each pixel location within the block of image data of the current frame based upon a direction associated with the pixel location includes,
program instructions for determining whether a direction associated with a pixel is of a horizontal direction or a vertical direction.

25. The computer readable medium of claim 24, further comprising:
program instructions for identifying a gradient value associated with the pixel;
program instructions for defining a horizontal component of the gradient value;
program instructions for defining a vertical component of the gradient value; and
program instructions for calculating a magnitude of the gradient value from the horizontal component and the vertical component.

26. The computer readable medium of claim 23, wherein the program instructions for applying a weighted interpolation scheme adaptively to each pixel location within the block of image data of the current frame based upon a direction associated with the pixel location includes,
program instructions for transforming coordinates representing one of the each pixel location through a function having a sigmoidal shape.

27. A system for processing block based image data, comprising:
an encoder configured to compress video data, the encoder configured to set a coded block indicator to a first value when inter frame redundancies between corresponding blocks of successive frames of a video stream exceed a threshold value, the encoder further configured to set the coded block indicator to a second value when the inter frame redundancies between successive frames of a video stream are less than or equal to the threshold value;
a decoder configured to decompress the video data, and
a scaling module configured to scale the decompressed video data, the scaling module including circuitry for identifying the coded block indicator for each block, the scaling module further including circuitry for adaptively applying a weighted interpolation scheme to a pixel location within a current frame when the coded block indicator is equal to the first value.

28. The system of claim 27, wherein the threshold value represents a summation of differences between corresponding pixel values of the successive frames of the video stream.

29. The system of claim 27, wherein the circuitry for adaptively applying a weighted interpolation scheme includes circuitry for copying a block corresponding to the pixel location from a previous frame when the coded block indicator is equal to the second value.

30. The system of claim 27, wherein the scaling module is incorporated into the decoder.

31. The system of claim 27, wherein the circuitry for adaptively applying a weighted interpolation scheme includes circuitry for determining whether a direction associated with a gradient corresponding to the pixel location is a horizontal direction or a vertical direction.

32. The system of claim 31, wherein the circuitry for determining whether a direction associated with a gradient corresponding to the pixel location is a horizontal direction or a vertical direction includes,
circuitry for calculating a magnitude of the gradient from both a horizontal component of the gradient and a vertical component of the gradient.

33. An integrated circuit capable of scaling image data, comprising:
logic for calculating a gradient value associated with a pixel location of the image data;
logic for determining whether an angle defined by a vector associated with the gradient value and an axis is a substantially parallel angle or a substantially perpendicular angle; and
logic for applying a weighted interpolation scheme to the pixel location when a) the direction is a horizontal direction or a vertical direction and b) the gradient value exceeds a threshold value.

34. The integrated circuit of claim 33, further comprising:
logic for applying a bilinear interpolation scheme or a bicubic interpolation scheme to the pixel location when the direction is a non-horizontal direction or a non-vertical direction.

35. The integrated circuit of claim 33, wherein the logic for identifying a gradient value associated with a pixel location of the image data includes,
logic for determining a partial derivative associated with the pixel location.

36. The integrated circuit of claim 33, wherein the logic for determining whether a direction associated with the pixel location is one of a horizontal direction and a vertical direction includes,
logic for defining a horizontal component of the gradient value;
logic for defining a vertical component of the gradient value; and
logic for calculating a magnitude of the gradient value from the horizontal component and the vertical component.

37. The integrated circuit of claim 36, further comprising:
logic for computing a direction angle associated with the pixel location based upon both the horizontal component and the vertical component;
logic for comparing the magnitude of the gradient value to a threshold value; and
logic for applying a bilinear interpolation scheme or a bicubic interpolation scheme to the pixel location when the threshold value is greater than the gradient value.

38. The integrated circuit of claim 33, wherein each logic element is hardware, software, or combination thereof.

39. An integrated circuit capable of scaling video data, comprising:
logic for determining whether a block of image data of a current frame is flagged to indicate a level of difference with a corresponding block of image data of a previous frame;
logic for applying a weighted interpolation scheme adaptively to a pixel location within the block of image data of the current frame based upon a direction associated with the pixel location, wherein the block of image data of the current frame is associated with a flag indicative of a level of difference with the corresponding block of image data of the previous frame; and
logic for applying a bilinear interpolation scheme when the direction associated with the pixel location excludes the weighted interpolation scheme.

40. The integrated circuit of claim 39, wherein the logic for applying a weighted interpolation scheme adaptively to a pixel location within the block of image data of the current frame based upon a direction associated with the pixel location includes,
logic for transforming coordinates representing a particular pixel location through a function associated with a sigmoidal shape.

41. The integrated circuit of claim 39, wherein the logic for applying a weighted interpolation scheme adaptively to a pixel location within the block of image data of the current frame based upon a direction associated with the pixel location includes,
logic for determining whether a direction associated with a pixel is a horizontal direction or a vertical direction.

42. The integrated circuit of claim 39, further comprising:
logic for detecting the flag.

43. The integrated circuit of claim 39, wherein each logic element is hardware software, or combination thereof.
